(19) United States
(12) Patent Application Publication
(10) Pub. No.: US 2006/0026414 A1
(43) Pub. Date: Feb. 2, 2006

(54) Managing the environmental configuration for an application disposed in removable storage

(75) Inventors: Joseph Eric Firebaugh, Apex, NC (US); Jason Michael Brown, Durham, NC (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 10/902,217

(22) Filed: Jul. 29, 2004

(51) Int. Cl. G06F 15/177

(52) U.S. Cl. 713/1

(57) ABSTRACT

A method, system and apparatus for managing environmental configuration for removable storage. A removable storage configured to store at least one host application installation for one or more host computing systems can include a service registry module (SRM) configured to store environmental configuration data for an application installed in the removable storage. The removable storage further can include an SRM utility programmed to manage access to the SRM for the installed application through access requests received in a coupled one of the host computing systems. The SRM utility can be further programmed to write environmental configuration data to the SRM for a new application when the new application is installed in the removable storage.

### BACKGROUND OF THE INVENTION

1. Statement of the Technical Field

The present invention relates to removable storage, and more particularly to the environmental configuration for an application disposed in removable storage.

2. Description of the Related Art

Plug-and-play, removable mass storage has become the rage of the early twenty-first century. From solid state removable mass storage devices such as Compact Flash™, Smart Digital™, and Memory Stick™ technology, to mechanical platter based storage devices such as the Microdrive™, digital data no longer remains bound to the bulky and largely non-portable confines of the fixed disk drive. In the context of Compact Flash, Smart Digital and Memory Stick technologies, a proprietary interface ordinarily will be required. Though the various interface specifications have been widely publicized and standardized as a matter of course, the selection and inclusion of a proprietary interface within a computing design can be expensive, require end-user configuration and can consume excessive power.

In view of the traditional difficulties associated with coupling and engaging solid state removable mass storage devices through a proprietary interface to the personal computing device, recently it has become popular to couple and engage solid state removable mass storage devices through the existing input/output ports of the personal computing device. While hard and floppy disk drives, CD-ROM, DVD-ROM, DVD-R and CDR devices have been coupled to and engaged with personal computing devices through parallel and serial input/output ports, the use of the parallel and serial input/output port has never gained a level of ubiquity expected primarily due to the requirement that devices are attached therethrough prior to boot strap.

The universal serial bus (USB) specification addressed the principal concern of peripheral component manufactures in the ability of the USB port to dynamically activate and configure an attached device in a “plug-and-play” fashion. Since its introduction, the USB interface has rapidly become the interface of choice. To that end, USB mass storage devices barely the size of a human thumb have been popularized. Removable USB mass storage devices of late include both flash memory configurations and Microdrive configurations. Thus, the USB interface presently provides an efficient mechanism for rapidly and effortlessly added mass storage to an operating personal computing device without requiring complicated configuration and a re-booting of the personal computing device.

Though removable storage devices have proven to be handy for rapidly transferring data between machines, storing application logic—particularly computer programs—in removable storage is not feasible in as much as the modem computer program often requires substantial environmental configuration. Typical configurations involve the modification of the operating system registry, or the addition of data to the operating system registry, the creation of operating system folders, the inclusion of desktop shortcuts, and optionally the disposition of library objects to a common storage area in the computing system, to name just a few. Due to the involved nature of the environmental configuration process, it can be unrealistic to install an application to removable storage expecting to be able to utilize the application across multiple computing systems having computing environments which have not been fully configured.

Ironically, it has been suggested that removable storage devices suffice as a sufficient platform for storing environmental configuration data for use when operating applications stored within the host computing device. For instance, in U.S. patent application Publication No. US 2004/0001088 A1 to Stancil et al. for PORTABLE ELECTRONIC KEY PROVIDING TRANSPORTABLE PERSONAL COMPUTING ENVIRONMENT, at is noted that “A portable personal configuration device contains non-volatile memory and can be used to quickly and efficiently transport a user's personalized computing environment from one computer to another.” Examples of personalized configuration data are cited to include Internet favorites and cookies, software keys, desktop icons and games settings, to name a few. Still, without providing a platform for transporting and hosting an application within removable storage, the Stancil reference fails to overcome the deficiencies recited above.

### SUMMARY OF THE INVENTION

The present invention addresses the deficiencies of the art in respect to configuration management for applications and data disposed within removable storage and provides a novel and non-obvious method, system and apparatus for managing environmental configuration for removable storage. A method of managing environmental configuration data for an application disposed in removable storage can include intercepting a request to access environmental configuration data disposed in a host computing system. Subsequently, environmental configuration data disposed in the removable storage can be retrieved. Consequently, the request can be satisfied using both environmental configuration data disposed in the host computing system and the retrieved environmental configuration data disposed in the removable storage.

In a preferred aspect of the invention, the method also can include further intercepting a request to install an application to the removable storage, yet further intercepting a request to write environmental configuration data to a registry in the host computing system in association with the further intercepted request, and causing the removable storage to write the environmental configuration data associated with the further intercepted request to a registry disposed in the removable storage. In any case, the satisfying step can include incorporating the retrieved environmental configuration data disposed in the removable storage in a registry lookup operation in the host computing system. Additionally, the satisfying step can include writing changes to environmental configuration data associated with applications disposed in the removable storage to a registry disposed in the removable storage.

Preferably, responsive to coupling the removable storage device to the host computing system, environmental configuration data associated with applications disposed in the removable storage device can be retrieved and applied to a configuration of the host computing system. Conversely, responsive to decoupling the removable storage device from the host computing system, environmental configuration data associated with applications disposed in the removable storage device which had been applied to the configuration of the host computing system can be removed.

In a preferred aspect of the invention, a removable storage configured to store at least one host application installation for one or more host computing systems can include a service registry module (SRM) configured to store environmental configuration data for an application installed in the removable storage. The removable storage further can include an SRM utility programmed to manage access to the SRM for the installed application through access requests received in a coupled one of the host computing systems. The SRM utility can be further programmed to write environmental configuration data to the SRM for a new application when the new application is installed in the removable storage.

Importantly, once installed, an application can be transferred from a host computing system to removable storage. Conversely, an application disposed in removable storage can be transferred to a host computing system. In the former circumstance, the SRM utility can remove the environmental configuration data from the host computing system placing the environmental configuration data onto the removable storage in the SRM. In contrast, in the latter circumstance, the SRM utility can remove the environmental configuration data from the SRM in the removable storage placing the environmental configuration data into the host computing system.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a system, method and apparatus for managing the environmental configuration for an application disposed in removable storage in accordance with the present invention;

FIG. 2 is a schematic illustration of a computing system configured for managing the environmental configuration for an application disposed in removable storage; and,

FIG. 3 is a flow chart illustrating a process for managing the environmental configuration for an application disposed in removable storage in the system of FIG. 2.

### DETAILED DESCRIPTION OF THE PREFERRED EMBODIMENTS

The present invention is a method, system and apparatus for managing the configuration of an application environment when the application has been installed in removable storage. In accordance with the present invention. A service registry utility can monitor the process of installing an application to removable storage. Requests to change the environmental configuration of the host computing system, including registry entries, can be intercepted in order to cause the changes to be recorded in the removable storage. The service registry utility can remain activated in the computing system or any other computing system to which the removable storage has been coupled so that requests to access the environmental configuration can be intercepted so as to incorporate the environmental configuration data stored in the removable storage along with the environmental configuration of the host computing system.

In this way, applications can be transported from one computing system to the next in removable storage without regard to the environmental configuration requirements of the host computing system. Ordinarily, application installation is tied to the host computing system to which the application has been installed, though the application belongs to an owner and not a computing system. Utilizing the system, method and apparatus of the present invention, installations computer programs can be linked directly to the end user by way of the removable storage to which the computer program has been installed and not to any particular computing system. Finally, utilizing applications installed to removable storage, whole computer applications can be distributed to the consuming public on removable mass media without requiring an additional installation process.

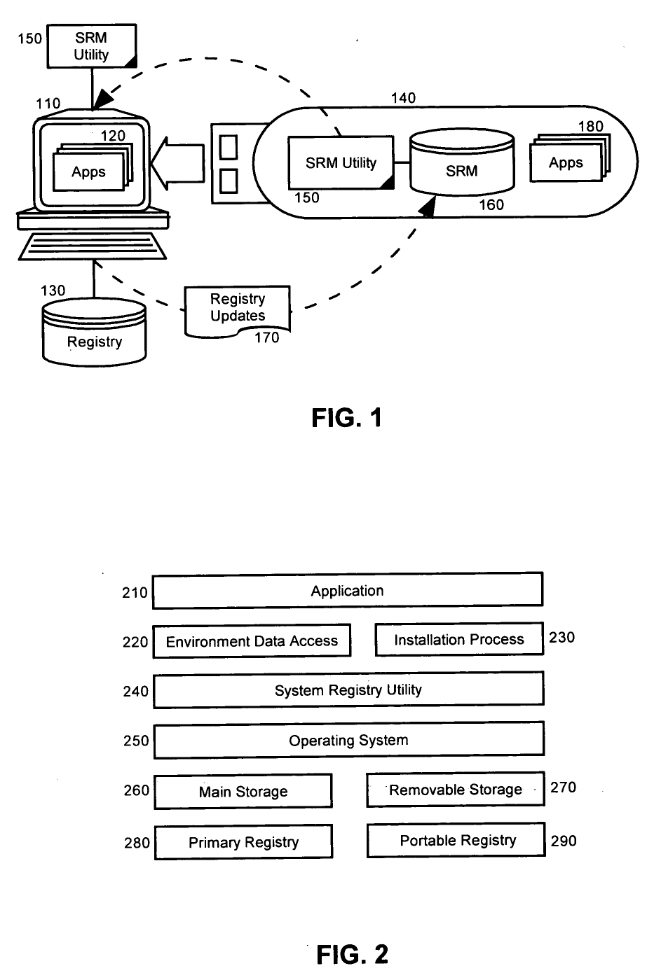

In further illustration of the present invention, FIG. 1 is a pictorial illustration of a system, method and apparatus for managing the environmental configuration for an application disposed in removable storage in accordance with the inventive arrangements. In accordance with the present invention, removable storage device 140 can be removably coupled to a host computing device 110 and can behave as another storage medium able to be accessed by the file system of the host computer as if the removable storage device 140 were permanently included as part of the hosting computing device. The host computing device 1 10 can include fixed storage in which one or more applications 120 can be stored for execution within the host computing device 110. To support the installation and operation of the applications 120, a registry of environmental configuration data 130 can be maintained within the host computing device 110 as well.

The removable storage device 140 can host one or more applications 180 as well as a service registry module (SRM) 160. In particular, the SRM 160 can store environmental configuration data relating specifically to those applications 180 stored in the removable storage device 140. Finally, an SRM utility 150 can be disposed within the removable storage device 140 so as to be distributable to host computing systems temporarily coupled to the removable storage device 140, including the host computing system 110. In this regard, the SRM utility 150 can be an application programmed to load and remain resident in the background of a host computing device 110.

Once loaded and operational, the SRM utility 150 can trap requests to install applications 180 to the removable storage device 140. By trapping the installation requests, the SRM utility 150 can ensure that environmental configuration data 170 to be added or changed in the registry 130 can be written instead to the SRM 160. Additionally, the SRM utility 150 can trap requests to access the registry 130 so as to ensure that the environmental configuration data stored in the SRM 160 can be accounted for in the access request. For instance, where the SRM utility 150 traps a request to locate specific environmental configuration data in the registry 130, the SRM utility 150 can ensure that the environmental configuration data in the SRM 160 is included in the process of satisfying the location request.

In more particular illustration of a preferred architecture for a computing environment configured for use with the SRM utility 150 of FIG. 1, FIG. 2 is a schematic illustration of a computing system configured for managing the environmental configuration for an application disposed in removable storage. As shown in FIG. 2, an operating system 250 can manage both main storage 260 and removable storage 270. Main storage 260 can include a primary registry of environmental configuration data which can include not only system and program registry entries, but also desktop settings such as icon settings and placement and menu formats and content, file system preferences including folders and directory hierarchies, and the like. The removable storage 270, by comparison, can include a portable registry 290 which can store environmental configuration data relating to applications stored within the removable storage 270.

The SRM Utility 240 can be loaded into the host computing device above or as part of the operating system 250. The SRM Utility 240 can intercept or otherwise trap requests generated as part of an installation process 230 for an application 210, or as part of an access request 220 to access the primary registry 280 on behalf of an application 210 installed in the removable storage 270. In the course of handling requests generated as part of the installation process 230, the SRM Utility 240 can ensure that environmental configuration data associated with the application 210 are written to the portable registry 290 and not to the primary registry 280. Similarly, in the course of handling requests generated as part of an access request 220, the SRM Utility 240 can ensure that the environmental configuration data associated with the application 210 and stored in the portable registry can be included and accessed as if the environmental configuration data had been stored in the primary registry.

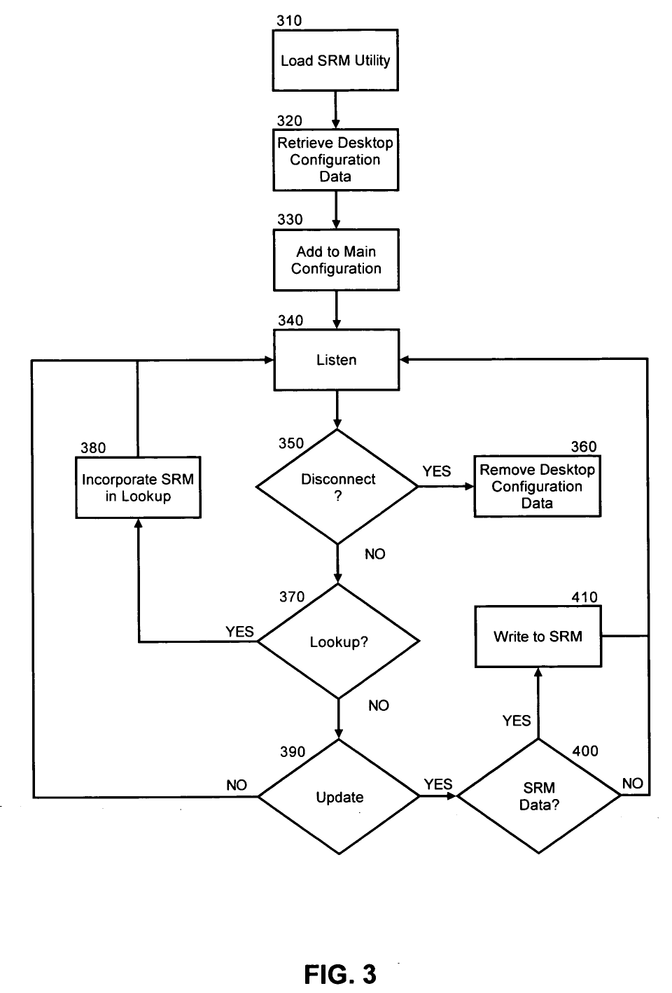

In this regard, FIG. 3 is a flow chart illustrating a process for managing the environmental configuration for an application already installed in removable storage. Beginning in block 310, as the removable storage is coupled to a host computing system, the SRM Utility can be loaded into memory and the SRM Utility can execute as a background process in the host computing system. In block 320, environmental configuration data stored in the removable storage for applications stored in the removable storage can be retrieved and in block 330 the data can be applied to the host computing system, including desktop configuration and file system configuration data. Examples can include “Start Menu” additions, desktop icons and the like.

In block 340, the SRM Utility can “listen” for events pertinent to the operation of the SRM Utility. Examples can include the disconnection of the removable storage from the host computing device, a request to access environmental configuration data such as a registry lookup, and a request to update environmental configuration data such as a write to the registry. Specifically, in decision block 350 if an event is detected indicating the disconnection of the removable storage from the host computing system, in block 360 the applied environmental configuration data can be removed as access to the applications disposed in the removable storage no longer will be able to be accessed by users of the host computing system.

In decision block 370, if an event is detected indicating a registry lookup request, in block 380, the registry entries of the removable storage can be combined with the registry entries of the host computing system to provide a composite registry in a manner which is seamless to the requestor. Finally, in decision block 390 if an event is detected indicating a request to update environmental configuration data in the registry in the host computing system, in decision block 400 it can be determined if the subject environmental configuration data relates to an application which has been installed in the removable storage. If so, in block 410 the updated environmental configuration data can be written to the SRM in the removable storage in lieu of writing the environmental configuration data to the registry of the host computing system.

In consequence of the present invention, applications can be installed directly to removable storage. The environmental configuration matters associated with the operation of the installed application can be managed in a portable fashion through the disposition of the SRM Utility in host computing systems. In this way, the use and operation of the application can be tied more directly to the end user and not the host computing system to which the application has been installed. As a result, new applications distribution possibilities not previously feasible can be envisioned including the installation-free distribution of computer programs and the transportability of very large computer programs whose size exceeds the available storage of more traditional portable media.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A method of managing environmental configuration data for an application disposed in removable storage, the method comprising the steps of:
intercepting a request to access environmental configuration data disposed in a host computing system;
retrieving environmental configuration data disposed in the removable storage; and,
satisfying said request using both environmental configuration data disposed in said host computing system and said retrieved environmental configuration data disposed in the removable storage.

2. The method of claim 1, further comprising the steps of:
further intercepting a request to install an application to the removable storage;
yet further intercepting a request to write environmental configuration data to a registry in said host computing system in association with said further intercepted request; and,
causing the removable storage to write said environmental configuration data associated with said further intercepted request to a registry disposed in the removable storage.

3. The method of claim 1, further comprising the step of responsive to coupling the removable storage device to said host computing system, retrieving environmental configuration data associated with applications disposed in the removable storage device and applying said retrieved environmental configuration data to a configuration of said host computing system.

4. The method of claim 3, further comprising the step of responsive to decoupling the removable storage device from said host computing system, removing from said host computing system, environmental configuration data associated with applications disposed in the removable storage device and which had been applied to said configuration of said host computing system.

5. The method of claim 1, wherein said satisfying step comprises the step of including said retrieved environmental configuration data disposed in the removable storage in a registry lookup operation in said host computing system.

6. The method of claim 1, wherein said satisfying step comprises the step of writing changes to environmental configuration data associated with applications disposed in the removable storage to a registry disposed in the removable storage.

7. A removable storage configured to store at least one host application installation for a plurality of host computing systems, the removable storage comprising:
a service registry module (SRM) configured to store environmental configuration data for an application installed in the removable storage; and,
an SRM utility programmed to manage access to said SRM for said installed application through access requests received in a coupled one of the host computing systems.

8. The removable storage of claim 7, wherein the SRM utility is further programmed to write environmental configuration data to said SRM for a new application when said new application is installed in the removable storage.

9. The removable storage of claim 7, wherein the SRM utility is further programmed to transfer environmental configuration data to said SRM for an application stored in said coupled one of the host computing systems when transferring said application to the removable storage.

10. The removable storage of claim 7, wherein the SRM utility is further programmed to transfer environmental configuration data from said SRM to said coupled one of the host computing systems for an application stored in the removable storage coupled when transferring said application to said coupled one of the host computing systems.

11. A machine readable storage having stored thereon a computer program for managing environmental configuration data for an application disposed in removable storage, the computer program comprising a routine set of instructions which when executed by a machine cause the machine to perform the steps of:
intercepting a request to access environmental configuration data disposed in a host computing system;
retrieving environmental configuration data disposed in the removable storage; and,
satisfying said request using both environmental configuration data disposed in said host computing system and said retrieved environmental configuration data disposed in the removable storage.

12. The machine readable storage of claim 11, further comprising a routine set of instructions for further causing the machine to perform the steps of:
further intercepting a request to install an application to the removable storage;
yet further intercepting a request to write environmental configuration data to a registry in said host computing system in association with said further intercepted request; and,
causing the removable storage to write said environmental configuration data associated with said further intercepted request to a registry disposed in the removable storage.

13. The machine readable storage of claim 11, further comprising a routine set of instructions for further causing the machine to perform the step of, responsive to coupling the removable storage device to said host computing system, retrieving environmental configuration data associated with applications disposed in the removable storage device and applying said retrieved environmental configuration data to a configuration of said host computing system.

14. The machine readable storage of claim 13, further comprising a routine set of instructions for further causing the machine to perform the step of, responsive to decoupling the removable storage device to said host computing system, removing from said host computing system, environmental configuration data associated with applications disposed in the removable storage device and which had been applied to said configuration of said host computing system.

15. The machine readable storage of claim 11, wherein said satisfying step comprises the step of including said retrieved environmental configuration data disposed in the removable storage in a registry lookup operation in said host computing system.

16. The machine readable storage of claim 11, wherein said satisfying step comprises the step of writing changes to environmental configuration data associated with applications disposed in the removable storage to a registry disposed in the removable storage.
